(19) United States
(12) Patent Application Publication
(10) Pub. No.: US 2023/0151628 A1
(43) Pub. Date: May 18, 2023

(54) VEHICLE PARKING/STORAGE SYSTEM WITH CHARGER

(71) Applicants: Manuel HUCH, Haltern am See (DE); Markus MIKA, Haltern am See (DE); Martin MIKA, Haltern am See (DE); Lucas MIKA, Haltern am See (DE)

(72) Inventors: Manuel HUCH, Haltern am See (DE); Markus MIKA, Haltern am See (DE); Martin MIKA, Haltern am See (DE); Lucas MIKA, Haltern am See (DE)

(21) Appl. No.: 17/985,213

(22) Filed: Nov. 11, 2022

(30) Foreign Application Priority Data
Nov. 15, 2021 (EP) 21208309.1

(51) Int. Cl. E04H 6/14; H02G 11/00; B60L 53/30; B60L 53/60

(52) U.S. Cl. CPC E04H 6/14; B60L 53/30; B60L 53/60; H02G 11/006

(57) ABSTRACT

A storage/parking system has a vertical base structure defining a loading station and a storage/parking station thereabove. A drive moves a plurality of gondolas vertically along the structure, and a power supply is provided in at least one of the gondolas. A feed cable extends from a fixed point on the structure to the supply, and a flexible element secured to the one gondola for movement therewith guides the feed cable between the point and the supply.

### FIELD OF THE INVENTION

The present invention relates to a system for storing and/or parking large object such as vehicles. More particularly this invention concerns a parking tower.

### BACKGROUND OF THE INVENTION

A storage/parking system preferably for motor vehicles, bicycles etc., in particular is formed as a vertical park tower with a plurality of parking gondolas moveable by a drive vertically along, over, and under a stationary base structure, and an electrical power source for at least some of these gondolas. In this manner each gondola is movable through a loading/unloading station and along a path passing normally up one side of the base structure, past the top thereof, and then down the other side of the base structure.

Such storage/parking systems are also called vertical park towers and operate according to the paternoster principle. Thus the base structure extends vertically as a central column structure and the gondolas move in a closed path like the cabs of a paternoster elevator. The individual gondolas are moved together by an endless circulating chain with respective chain links along the sides of the base structure and through one or more loading/unloading stations at the upper and or lower end of the frame and through parking/storage stations on the sides of the frame. Instead of a separate chain carrying the gondolas, these gondolas themselves can form the links of a chain. The result is a system with a small footprint can be used to store a large number of large objects like cars, which is particularly interesting in urban situations. As a result such storage/parking facilities or vertical storage/parking facilities enjoy increasing popularity.

A storage/parking system and in particular a vertical parking tower with several circulating driven parking gondolas and thus embodying the basic principle is described for example in US 2004/0156699. This system has a chain drive that is reeved over large upper and lower wheels in turn driven by small sprockets meshing with teeth on the wheel or on a large gear rotationally fixed to the wheel.

A comparable storage/parking system is subject of DE 20 2017 100 651. Here the base structure is provided with reinforcement elements to stiffen it. Furthermore at least one of the parking gondolas is equipped with a power supply.

In more recent times increasing requirements arise in that the motor vehicles in or on the parking gondolas need to be supplied with electricity to charge their batteries. This is needed for all-electric or hybrid, that is gas/electric, powered vehicles. Likewise is it conceivable, to use the storage/parking system for example to store/park bicycles or motorcycles with electric drives so that when parked they can be charging.

For this reason the prior art of WO 2018/167796 proposes that some or all of the parking gondolas are equipped with an electrical hook up or power supply. Electrical feed cables can then supply charger for the vehicle, the two-wheeler, tricycle or other electrically operated motor vehicle with the necessary electrical energy while it is parked. Thus the parking time is optimally used for charging the rechargeable batteries in the motor vehicle. For this purpose according to this reference shows in its FIGS. 2C and 2D a commutator ring used to supply the parking gondola with the required electrical energy.

Such sliding-contact systems are however disadvantageous for several reasons. First, the electrified rotating surface and the contact engaging it must be effectively shielded to protect it from rain, humidity, dust, etc. that would damage them or make them fail to work. In addition, the sliding connection is subject to wear, so that constant maintenance and if necessary frequent replacement is necessary and thus high maintenance costs arise. Finally in this context not only weather caused short circuits are possible, but the nowadays used high charging voltages of several hundred volts constitute a large load on the contacts and typically create sparks or arcs. The again leads to a bulky and consequently costly structure.

### OBJECTS OF THE INVENTION

It is therefore an object of the present invention to provide an improved vehicle parking/storage system.

Another object is the provision of such an improved vehicle parking/storage system that overcomes the above-given disadvantages, in particular that is particularly set up to provide reliable charging for at least some of the vehicles being stored or parked.

Another object is to provide such an arrangement that allows significant power to be supplied to the parking gondolas without the problems inherent with sliding contacts and the like.

### SUMMARY OF THE INVENTION

A storage/parking system has according to the invention a vertical base structure defining a loading station and a storage/parking station thereabove. A drive moves a plurality of gondolas vertically along the structure, and a power supply is provided in at least one of the gondolas. A feed cable extends from a fixed point on the structure to the supply, and a flexible element secured to the one gondola for movement therewith guides the feed cable between the point and the supply.

According to the invention a plurality of the parking gondolas of the storage/parking system according to the invention is equipped with a respective electrical connection or supply, in particular a charger, as well as a respective feed cable. In addition, the respective electrical feed cable are each guided in a respective flexible guide element to the respective electrical connection or supply. The electrical supply may be thereby at a edge of a floor of the park gondola where the motor vehicle, bicycle etc. is resting. Other mounting possibilities of the electrical supply are conceivable. Thus the supply can be mounted overhead in the gondola as well as on the floor thereof according to the invention. The supply can even be an inductive charger that, for instance, is built into the floor of the gondola for contract-free charging.

Of course the storage/parking system according to the invention is also suitable for vehicles without electric drive, which in this case are simply parked on the floor and do not require the electrical supply for electrical charging. Furthermore it is of course also within the scope of the invention, that the electrical supply not only recharges accumulators in full-electric or hybrid motor vehicles with electrical energy, but also the electrical supply can maintain the charge of a standard motor-vehicle battery of an internal combustion engine and/or recharge it, if the concerned vehicle it must be parked or stored for a long time, for instance through or during winter. Furthermore it is conceivable, with the help of the electrical supply to heat the relevant vehicle and thus to keep it ready for use, which is particularly useful when the storage/parking system is set up in, for example, arctic areas.

To do this in detail, the parking gondolas are normally connected to each other by an endless traction chain looped over upper and lower drive wheels. The parking gondolas are each suspended from a respective arm projecting laterally from the traction chain. This traction chain entrains the flexible guide element. Each narrow side of the normally rectangular floor of the parking gondola and consequently also of the narrow side of the base structure has are two coaxial wheels carrying the traction chain and the flexible guide element.

The connection between the traction chain and the flexible guide element by providing loosely interconnected entrainment formations. For instance the traction chain is provided with a plurality of laterally projecting pins received with some play in respective seats formed in the guide element. Thus as the traction chain travels around its endless path, it synchronously pulls the guide element holding the cables.

Furthermore the drive wheels are formed in each case as double wheels for guiding on the one hand of the flexible traction chain and on the other hand of the flexible guide element. For example one wheel of the double wheel serves for guiding and advancing the traction chain and the other wheel for advancing the guide element. Both wheels are rotatably mounted on the base structure for coaxial rotation.

Furthermore the guide chain is connected to two fixed points of the base structure. The two fixed points are normally at the upper end of the base structure. In addition the guide element passes only over the upper wheel of the base structure. In contrast the traction chain is guided around both the upper and lower wheels on the base structure.

More particularly, upper and lower wheels are provided on the one narrow side of the base structure as well as also on the other narrow side of the base structure at the top and bottom of the base structure. In addition the two wheels are each rotatable on the base structure. Each flexible traction chain goes around one upper wheel and the respective lower wheel. In contrast the flexible guide chain extends starting from its two fixed points only over the respective upper wheel of the base frame. Here as stated above there is normally a respective double wheel for the traction chain on the one hand and the flexible guide element on the other hand.

Since the guide elements each extend from the two fixed points at the upper end of the basic frame only over the rotatable guide/drive wheel at this upper end of the basic frame, the guide chain can be moved as seen in front view from and the narrow side of the basic frame between a position hanging in a full-height loop to one side of the base structure to an other position hanging in a full-height loop to the other side of the base structure and through an intermediate position hanging in two half-height loops on opposite sides of this structure. The is explained in more detail below.

For holding and guiding the one or more electrical cables, the guide element is formed as a guide chain with U-section links. As consequence, the drive wheels are double wheels for moving both the traction chain and the guide element. Thereby advantageously design is further that the U-shaped chain links guide in addition to the at least one electrical feed cable at least one data line. The data line is itself connected to a controller. In this way, load can be managed as described below. In addition, this allows the controller to control each individual supply.

The U-shaped chain links guide and hold the electrical feed cable(s) as well as the data line(s) kept apart by separators that ensure that the various cables and lines always extend parallel to each other. In this way perfect guidance of the individual lines is ensured, also and in particular for the case when several electrical feed cables are provided. Furthermore the various lines are fixed by respective strain reliefs at the chain links. This way possible tensions between on the one hand the respective chain link and consequently the guide chain and on the other hand the cables are avoided and a possible cable break is prevented in advance.

The chain links are furthermore advantageously equipped with lateral drive pins for engagement in the double pinions. I.e., the chain links of the guide chain are received by the guide pins by the double pinion and guided and otherwise entrained by the being coupled with the traction chain. As a result, the traction chain and the guide chain run predominantly synchronously.

The additional data lines and their containment and guidance by of the guide element or chain allow control of the individual electrical supplies by the controller. The data line is in constant communication between the controller and the individual electrical supplies even though hard wired. The is of special advantage, because radio transmission or wireless operation is avoided according to the invention expressly because such communication is problematic in steel structures with steel gondolas.

Furthermore such data communication with the help of the data lines to the energy supplies ensures that the available electrical power at the respective electrical supply or electrical supply can be limited or controlled from outside to prevent a possible overload of the local power supply or the local power networks.

At the same time the data line provides secure and permanent communication between the controller and the electrical supplies to allow monitoring of the actual power consumed, in effect metering this consumption. Thus after an upstream identification check and activation of the electrical supply, a user is not in any way overcharged for the used energy.

Overall, a storage/parking system, in particular for vehicles is made available that in a strikingly simple way and manner provides electrical supplies at some or all the parking gondolas of the inventive park tower. Any weather- or climate-related failures of the electrical supply are here expressly not to fear. In addition guidance of the respective electrical feed cables ensures with the help of the separate flexible guide chain durable and functionally safe operation. In combination with of the also provided data line furthermore ensures secure communication between the controller e.g. at the foot of the base structure or locally separated therefrom on the one hand and the individual electric supplies at or in the parking gondolas on the other hand. This way electrical load management is possible, thereby making possible accurate load management for the remote electrical power supplier.

Beyond that, the invention makes it possible for there to be two-way communication between electrical supply and for example in respective vehicle battery. Thus there is not only the possibility, that the vehicle’s rechargeable battery can be monitored at the respective supply. But just as well the accumulator can itself function as an energy source through the electrical supply and the respective electrical feed cable for feeding electrical energy into the electrical energy supply grid. The has hitherto not been possible. The same advantages are also present when, instead of motor vehicles, the gondolas hold large-volume consumer goods such as for example furniture, electrical appliances or other storage objects, which up to now are typically stored in so-called warehouses by users. In the framework of the invention now the individual park gondolas can act as storage units so that the storage/parking system according to the invention provides a type of circulating shelf. Since such storage units are usually provided at least with electric lighting usually also at least an outlet, the system of this invention provides at least an electrical supply as well as the respective electrical feed cable to of the gondola for the operation of a electrical light for example inside the storage box and/or an outlet. In addition the storage unit formed by the parking gondola is as a rule closed on all sides, around the herein stored contents to protect against possible environmental influences. Basically the storage units can also be at least partly open.

### BRIEF DESCRIPTION OF THE DRAWING

The above and other objects, features, and advantages will become more readily apparent from the following description, reference being made to the accompanying drawing in which:

FIG. 1 is a schematic side view of a parking system according to the invention;

FIGS. 2A-2C are views of the system in different positions; and

FIG. 3 is a perspective view of a link of the guide chain.

### SPECIFIC DESCRIPTION OF THE INVENTION

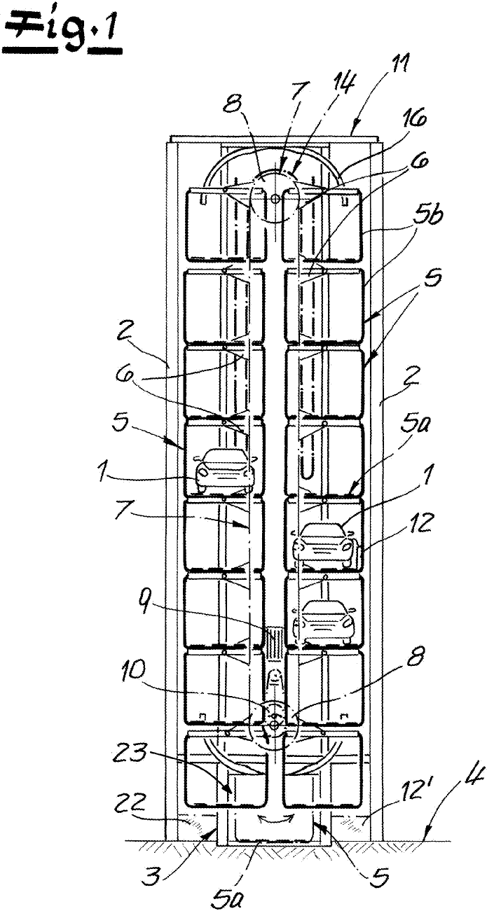

FIG. 1 shows a storage/parking system for vehicles 1. The vehicle 1 in question can e a hybrid or full-electric motor vehicle. The system can also work with standard bicycles, electric bicycles, electric motor bikes, electric quads, electric trucks etc. or with vehicles having conventional drive or even no drive.

For this purpose the storage/parking system can be equipped with one or several walls 2 or an open variant. In addition there is generally a stationary base structure 3 support on a floor 4, normally at or close to ground level. The base structure 3 can be a steel frame capable of supporting a plurality of, here eight, parking gondolas 5 each having in turn a floor 5a on which the respective vehicle 1 is parked. The floor 5a is spend by a framework 5b itself pivoted on a respective suspension arm 6 that is fixed to one or more links of an endless traction chain 7. Like the floor 5a, the base structure 3 is rectangular, seen from above. The narrow sides of the floor 5a and of the base structure 3 are aligned with each other.

The flexible and endless traction or traction chains 7 are each reeved between upper and lower wheels 8. One of the wheels 8 is at the top of the base structure 3 and the other is at its base, forming there a loading/unloading station 23. In addition the base structure 3 has on its front narrow side two of the wheels 8 with a respective the traction chain 7 passing over them and on the opposite narrow back side two identically constructed wheels 8 with the other endless traction chain 7. Thus the individual parking gondolas 5 move according to the paternoster principle with the aid of the two parallel traction chains 7 and the respective park gondolas 5 suspended from them.

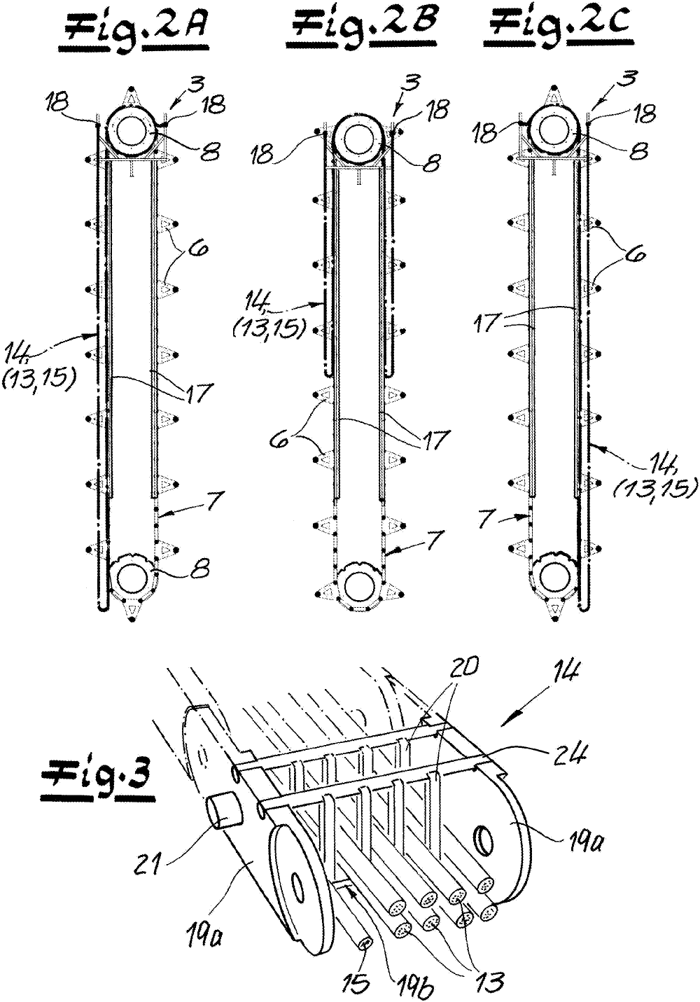

If one assumes in this context a complete orbital motion through 360° is effected, FIGS. 2A, 2B and 2C show equivalent movement starting from a middle FIG. 2B position at 0° in a direction to -180° to the FIG. 2A position and in the other direction +180° to the FIG. 2C position, so each of the represented parking gondolas 5 moves through the loading/unloading station 23.

When one of the gondolas 5 is in the station 23, the respective vehicle 1 can enter it and leave it at ground level. Once the vehicle 1 is loaded, a drive 9, 10 for the coupled parking gondolas 5 with each other is controlled so that as consequence of it the gondola 5 in the station 23 is moved vertically and/or horizontally. During such movement, it passes through several vertically offset levels, at each of which the vehicle 1 could be moved off horizontally, for parking or storage, normally above ground level. Of course it is also possible to work with other loading positions, for example with the vehicles 1 driving onto the floor 5a via a ramp to move above ground level for loading.

The drive 9, 10 is according to the embodiment formed by an electric motor 9 and a gear train or transmission including a drive wheel 10 that meshes with the links of the traction chain 7 and in this manner drives the endless traction chain 7. This produces the travel movement according to FIGS. 2A to 2C both in one direction (clockwise) and also in the other direction (counterclockwise), so that in this way each parking gondola 5 can move from the lower loading/unloading station 23 into one of the overhead storage/parking positions or stations and back again.

As mentioned above, the storage/parking system 1 according to the invention can be an open structure without closed side walls 2 and even without the roof 11. Then there are walls 2 and a roof 11, the walls 2 can be used for example as multimedia advertising surfaces. In addition the roof 11 can carry arrays of solar cells, as can the walls 2. An additional indicated battery storage 12′ can be provided so that during peaks the electrical charging of the individual vehicles 1 is interrupted, whereas otherwise electrical power can be stored in the battery storage 12′, which can also store extra energy from the solar cells.

Access to storage/parking system is possible via an automated access control with or without remote control. For this in the framework of the access control, authorization is checked. The authorization can be with a code entered by the vehicle driver at a terminal either with an RFID system or by use of a QR code or the like.

According to this invention some or all of the parking gondolas 5 are provided with a respective electrical supply 12. FIG. 1 shows only a single electrical supply 12 by way of example, but as mentioned more or all of the gondolas 5 can be thus equipped. With their help the respective vehicle 1 can be charged inductively. According to the illustrated embodiment the charging process however is carried out as shown in FIG. 1 by electrical connection cable between the vehicle 1 and the electrical supply or supply 12. In this example electrical power of 22 KW is made available. Further such supplies 12 can be provided at ground level, although that is not shown here.

According to the invention respective electrical feed cables 13 are provided for the supplies 12 that are held in a flexible guide chain 14 as shown in FIGS. 2A to 2C. In addition the chain 14 contains and guides a data line 15. The traction chain 7 and the trailing chain 14 are moved synchronously.

The setup is such that the parking gondolas 5 are connected with each other by the traction chain 17 spanned between the two wheels 8 and moved by the drive 9, 10, which chain 7 also drives the guide chain 14. For this the traction chain 7 is equipped with individual entrainment formations that fit in respective seats of the guide chain 14. The wheels 8 are double wheels or double pinions that entrain both the traction chain 7 and with the guide chain 14. For this purpose, the traction chain 7 with its double pinion and also the guide chain 14 with its double pinion move predominantly in respective parallel planes spaced from each other.

In addition a guide 16 is provided for the individual parking gondolas 5 or suspension arms 6 from which they are hung. In addition,a further guide 17 is provided for the guide chain 14. These are U-shaped guide rails.

The guide chains 14 are according to FIGS. 2A to 2C each connected to two fixed points 18 at the top of the base structure 3. The guide chain 14 starting from the a fixed point 18 passes only over the upper wheel 8 on the base structure 3, then falls as a loop connected to the other fixed point 18. In contrast each traction chain 7 is endless and reeved on both upper and lower wheels 8 with two reaches horizontally flanking the base structure 3. Thus the guide chain 14 as seen in front view in FIGS. 2A to 2C on the wheels 8 can move between the FIG. 2C position with its loop on the right side to the FIG. 2A position on the left side, passing through the FIG. 2B position half on the right and half on the left.

In this manner the guide chain 14 is moved both during rotation of the upper wheel 8 in the clockwise direction and also counterclockwise always mainly vertically and goes thereby from the position of FIG. 2A to the position of FIG. 2C and back. Thus all the parking gondolas 5 can move through both the loading station 23 and each other storing/parking position while connected to the respective electrical feed cables 13 and the data line 15 with the help of the guide chain 14. Since the cables 13 are connected permanently at each end, there are no sliding contacts and considerable amperage can be managed.

To do this, the guide chain 14 has a succession of identical U-section links with side plates 19a and cross plates 19b interconnected by cross bars 24 themselves interconnected by dividers 20 to form five windows through which the cables 13 and 15 extend. Thus these cables 13 cannot tangle to each other as the guide chain 14 moves. In addition the individual lines 13,15 are connected at regular intervals with help of strain reliefs to the links of the guide chain 14,in order to avoid any friction or mechanical loads of the lines 13,15.

Each electrical supply or electrical supply unit 12 has a respective electrical feed cable 13. Furthermore the electrical supply 12 is connected to the data line 15. This is best seen in FIGS. 2A to 2C that show the electric feed cables 13 starting from for example the left fixed point 18 in a loop via the upper wheel 18 to the other fixed point 18. In the area of the supply 12 the electrical feed cable 13 is connected to electrical supply 12 via a loop lying in a plane perpendicular to the view plant and lying, for example on the floor 5a of the parking gondola 5 to the electrical supply 12 and again back.

FIG. 3 shows that the individual chains links 19a, 19b are provided with lateral guide pins 21 that serve for engagement with the respective upper double pinion 8 rotatable on the basic frame 3. The data line 15 is connected to a controller 22 shown only in FIG. 1 at the bottom of the base structure 3. This controller 22 not only controls access to the system, but can also can determine how much electricity was consumed by the parked or stored vehicles for charging to the driver. In addition the controller 22 can control the consumption of the supplies 12, for instance limiting charging to off-peak times when rates are lower.

Overall, the invention a high-wattage connection between individual fixed points 18 that are connected to line and the supplies 12 in the movable gondolas, all without sliding contacts or other systems with limited load capacity and significant wear and upkeep costs. The permanent heavy-duty connection via the lines 13 allows high-voltage and high-amperage fast charging of the vehicles 1 in the system. Direct or alternating voltage can be supplied. In addition can with the help of the electrical supply 12 can power lighting of the respective gondola 5, and, in the event of malfunction, individual electrical supplies 12 can be switched off in a targeted manner with the aid of the controller 22 without impairing the other electrical supplies 12 and generally the function of the storage/parking system according to the invention.

The individual U-shaped chain links 19a, 19b of the guide chain 14 are made of plastic according to this embodiment. Here, it has proven particularly advantageous if the individual chain links 19a, 19b are plastic injection moldings. Thus at the same time an effective electrical insulation of the lines 13 and 15 between the two side plates 19a guided is realized and implemented. In addition a particularly low-friction and durable operation of the guide element and/or of the guide chain 14 is ensured. In contrast the traction chain 7 as a rule is made of steel. The applies also to the base structure 3 and usually also to the guides 16 and 17 as well as to the parking gondolas 5.

We claim:

1. A storage/parking system comprising:
a vertical base structure defining a loading station and a storage/parking station thereabove;
a plurality of gondolas;
a drive for displacing the gondolas vertically along the structure;
a power supply in at least one of the gondolas;
a feed cable extending from a fixed point on the structure to the supply; and
a flexible element secured to the one gondola for movement therewith and guiding the feed cable between the point and the supply.

2. The system according to claim 1, wherein the drive includes upper and lower wheels carried on the structure and an endless traction chain reeved over the wheels and carrying the gondolas.

3. The system according to claim 2, further comprising at least one entrainment formation on the chain or on the flexible element coupling the chain and element together for joint movement.

4. The system according to claim 2, the wheels are each double for driving the chain and the flexible element.

5. The system according to claim 2, wherein the flexible element extends between and has opposite ends connected to fixed points at an upper end of the structure.

6. The system according to claim 2, wherein the flexible passes only over the upper wheel.

7. The system according to claim 5, wherein the flexible element is movable between one end position hanging as a loop from the points to one side of the structure and another end position hanging as a loop from the points to an opposite side of the structure.

8. The system according to claim 4, wherein the flexible element is formed of links.

9. The system according to claim 8, wherein each of the links is of U-section and surrounds the feed cable on three sides.

10. The system according to claim 9, further comprising:
a data line connected to the supply and guided in the flexible elements.

11. The system according to claim 9, wherein there are a plurality of the supplies in respective ones of the gondolas and a plurality of the feed cables each connected to a respective one of the supplies, the flexible element further comprising separators forming respective passages through the links for the cables.

12. The system according to claim 11, further comprising:
strain reliefs between the cables and the links.

13. The system according to claim 9, wherein each of the links is provided with at least one entrainment formation for connection to the traction chain.

14. The system according to claim 10, further comprising:
a load controller connected to the supply via the data line.

15. The system according to claim 13, wherein the supplies are chargers operated by the controller.
